(19) United States
(12) Patent Application Publication
(10) Pub. No.: US 2015/0050152 A1
(43) Pub. Date: Feb. 19, 2015

(54) SEGMENTED WIND TURBINE HUB

(71) Applicant: SIEMENS AKTIENGESELLSCHAFT, MUNCHEN (DE)

(72) Inventor: HENNING EBBESEN, SKJERN (DK)

(21) Appl. No.: 14/305,018

(22) Filed: Jun. 16, 2014

(30) Foreign Application Priority Data
Aug. 14, 2013 (EP) 13180368.6

(51) Int. Cl. F03D 1/06

(52) U.S. Cl. CPC F03D 1/0691; F03D 1/0658
USPC 416/204 R; 416/244 R

(57) ABSTRACT

A segment of a wind turbine hub and a hub comprising a segment is provided. A wind turbine hub segment is disclosed, whereby the segment comprises a part of the outer surface of the hub. The segment comprises at least one area to connect a segment to at least one other segment. The area to connect the segment comprises a mainly closed surface.

### CROSS-REFERENCE TO RELATED APPLICATIONS

This application claims priority to EP Application No. 13180368.6, having a filing date of Aug. 14, 2013, the entire contents of which are hereby incorporated by reference.

### FIELD OF TECHNOLOGY

The following relates to a segment of a wind turbine hub and a hub comprising a segment.

### BACKGROUND

Wind turbines comprise at least one rotor blade that is connected to a hub. The hub is rotatable connected to the nacelle of the wind turbine. The nacelle is arranged rotatable on top off a tower. During operation of the wind turbine, the wind interacts with a rotor blade and rotates the hub. The rotation is transferred via the hub to the nacelle. Over the last years the development of the wind turbines leads to wind turbines in a higher power range. Meanwhile multi-megawatt wind turbines are common As the wind turbines are built at higher power levels, the wind turbines and its components are increased in size. Also the hub of the wind turbine was considerably increased in size over the last years. The hub of a wind turbine is mostly casted in one piece. This shows the disadvantage that there is a technical limitation to the size of casted objects. In addition, the hub is transported to the erection site of the wind turbine. Also there is a limitation to the maximum size of objects for land transportation.

It is therefore known to build a hub of a wind turbine in segments. The segments are casted independently and are transported to the erection site of the wind turbine. There the segments of the hub are connected to build the hub of the wind turbine. The segments of the hub are built in a way that they are connected at flanges by bolts, and form one hollow body. So the finished hub resembles the structure of the former non-segmented hub. The segmented hub shows several problems in relation to the non-segmented hub. One problem is to get sufficient strength of the bolted connection between the segments of the hub. Another problem is to achieve a sufficient stiffness of the segmented hub, to withstand the forces induced into the hub during the operation of the wind turbine. In addition, the transfer of the forces within the hub is influenced due to the unsteady walls of the hub.

### SUMMARY

An aspect relates to an improved segmented hub.

A wind turbine hub segment is disclosed, whereby embodiments of the segment comprise a part of the outer surface of the hub. The segment may comprise at least one area to connect a segment to at least one other segment. The area to connect the segment may comprise a mainly closed surface.

A hub of a wind turbine can be divided into at least two segments. A segment may comprise a part of the outer surface of the hub. The hub of a wind turbine is in general planned and built as a hollow body. The hub can comprise therefore a hollow space in the middle that is limited by the inner wall of the hub.

In addition, the body of the hub comprises an outer surface. The outer surface of the hub can be either visible from the outside when the hub is installed at a wind turbine or it is later covered by an enclosure. The outer surface of a hub may comprise at least one area to connect a rotor blade to the hub. Thus, a wind turbine hub segment may comprise an area or at least a part of an area to connect a rotor blade to the wind turbine hub segment. The segment may also comprise at least one area to connect the segment to at least one other segment. Thus, the segments can be connected together to form a hub of a wind turbine.

The area to connect the segment may comprise a mainly closed surface. The area to connect two segments can provide a large surface area that can be used to attach the segment to a second segment. The area to be used with connection means can be enlarged. Thus, the connection between two wind turbine hub segments can be more ridged.

In addition, the stiffness and stability of the wind turbine hub segment can be increased by the mainly closed surface. The mainly closed surface bridges a gap between two ends of the body of the hub segment. A segment of a hub is smaller than the hub itself and thus easier to transport and more lightweight. A wind turbine hub is normally casted in one piece. A wind turbine hub segment is smaller and is thus easier to be casted.

The segment is hollow and the mainly closed surface can be a wall of the segment. A wind turbine hub normally forms a hollow body. The mainly closed surface of the area to connect the segment to at least one other segment may form a wall of the wind turbine hub segment. A wind turbine hub, formed of at least two wind turbine hub segments thus is a hollow body, whereby the hollow space inside of the wind turbine hub can be divided by the wall of the segment. Thus, a side of a wind turbine hub can be connected to another side of the wind turbine hub by the wall reaching through the hollow space inside of the wind turbine hub. The sides of the wind turbine hub can be connected by a ridged wall. Thus, the wind turbine hub may show a higher stability and is more ridged in respect to deformation.

Moreover, the wall may comprise holes to be used by connection means when the segment is connected to a second segment. A plurality of connection means can be used to connect one segment to another segment along the surface of the wall of the segment. Thus, the connection means may be distributed over a larger surface, and the stiffness of the connection between the hub segments may be increased.

In some embodiments, the connection means are bolts or rivets. Bolts or rivets can be used to connect a wind turbine hub segment to at least one other wind turbine hub segment. The bolts or rivets can go through the holes in the walls of the segments. Bolts or rivets are common connection means that can easily be fixed at a construction site of the hub. Thus, the wind turbine hub segments can be transported to the construction site of the wind turbine separately and can be attached to each other at the construction site.

Embodiments of the wall may be prepared and arranged in a way that a connection to the second segment is established by welding. The walls of the segments that need to be connected may be prepared to be welded to each other. Thus, the walls are welded to each other. A welded connection is a very durable connection that, once established, may not need a regular service. Thus, a ridged connection is established and service time is saved.

Furthermore, the wall may comprise an opening to be used by an electric or hydraulic connection to connect an electric system or a hydraulic system that is used in the hub of the wind turbine. An electric or hydraulic connection is needed for an electric system or a hydraulic system like for example an electric pitch or a hydraulic pitch system for the rotor blades of the wind turbine. The pitch system, or a part of a pitch system, for the rotor blades is normally installed inside of the hollow body of the wind turbine hub. A connection to a pitch system or between two pitch systems can be established through an opening in the wall of the wind turbine hub segment. The pitch system of the rotor blades of the wind turbine can be distributed between the parts of the hollow space inside of the hub of the wind turbine. Thus, a system present in the hub segments can be connected to be operated as one system.

Embodiments of the segment may comprise a second connection area to connect a rotor blade to the segment. In other words, a rotor blade can be connected to a wind turbine hub segment. Components needed for the operation of a rotor blade can be arranged in the hollow space inside of a wind turbine hub segment. Thus, the wind turbine hub segment can be connected to the rotor blade and thereafter the wind turbine hub segments can be connected to form a hub of a wind turbine.

The hollow inner space of the segment may comprise at least a part of a pitch system and/or a control system and/or a pitch locking system. The space of a wind turbine hub segment can be used for a control system or a pitch system that is used for the operation of the wind turbine.

A wind turbine hub is disclosed, whereby the wind turbine hub may comprise at least one segment as described. A segment of a wind turbine hub is smaller and more light-weight than the wind turbine hub itself. The segment of a wind turbine hub is easier to transport and easier to install. Thus, transport capacity can be saved.

A wind turbine hub segment is smaller and comprises less mass. Thus, the manufacturing of a wind turbine hub segment is easier and less cost intensive than the production of a wind turbine hub in one piece.

Embodiments of the wind turbine hub can be connected by using a segment of a hub at a construction site of the wind turbine hub. The wind turbine hub segments are transported to the production site of the wind turbine hub. A wind turbine hub segment is smaller than a wind turbine hub. Thus, a wind turbine hub is easy to be transported and transportation costs are saved.

Embodiments of the hub may comprise three segments. A plurality of segments of a wind turbine hub can be connected to each other to form one wind turbine hub. In an exemplary embodiment, three segments of a wind turbine hub may be connected to form a single wind turbine hub.

Most embodiments of wind turbines comprise three rotor blades. The three rotor blades are connected to the hub of a wind turbine. The wind turbine hub may comprise three segments. Each of the segments may be prepared to be connected to one rotor blade. Each of the wind turbine hub segments may comprises one area to connect a rotor blade.

In addition, the components needed for the operation of the rotor blade can be installed in the inner hollow space of the wind turbine hub segment. The segments can be connected together to from a single wind turbine hub.

Embodiments of the plurality of segments of the wind turbine hub can be connected together after the rotor blades are connected to the wind turbine hub segments. The wind turbine hub segments can be connected together after they are hoisted up to the nacelle of the wind turbine together with the rotor blade attached to the wind turbine hub segment.

Embodiments of the wind turbine hub may comprise three identical segments to form the hollow structure of the hub. For example, three wind turbine hub segments can be used to form one wind turbine hub.

Each wind turbine hub segment may be a casted body. Three identical segments can be used to form one wind turbine hub. Thus, the wind turbine hub segments are identical bodies, and can be casted in an identical form. Thus, a wind turbine hub segment can be a standardized piece, which can make the production of the wind turbine hub segments easier, as only standardized pieces have to be produced.

In addition, transportation devices, needed for the transportation of the wind turbine hub segments, can be standardized. Thus, the logistics for the transportation of the wind turbine hub segments is easier, and the production and transportation of the wind turbine hub segments is easier and cheaper.

Furthermore, embodiments of the hub may comprise three connection areas to connect a rotor blade. Wind turbines with three rotor blades are effective wind turbines to transfer the energy of the wind into electrical energy. Thus, three-bladed wind turbines may show the lowest cost of material used in relation to the energy generated. The three-bladed wind turbines may show the lowest cost of energy produced.

### BRIEF DESCRIPTION

Some of the embodiments will be described in detail, with reference to the following figures, wherein like designations denote like members, wherein:

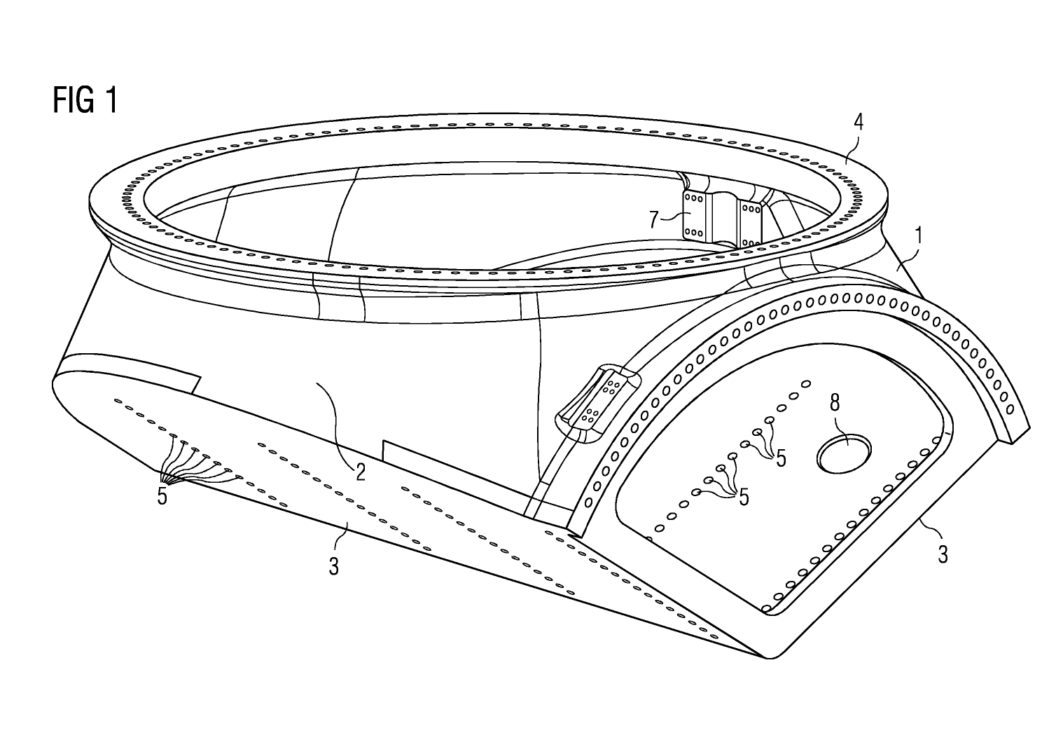

FIG. 1 shows an embodiment of a wind turbine hub segment;

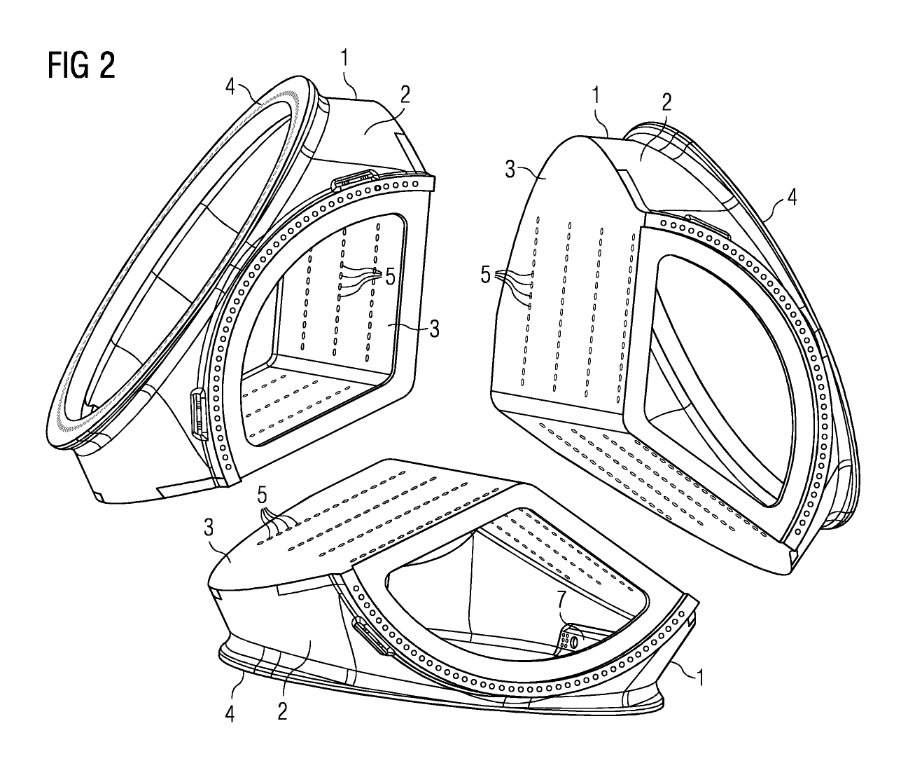

FIG. 2 shows an embodiment of a plurality of wind turbine hub segments; and

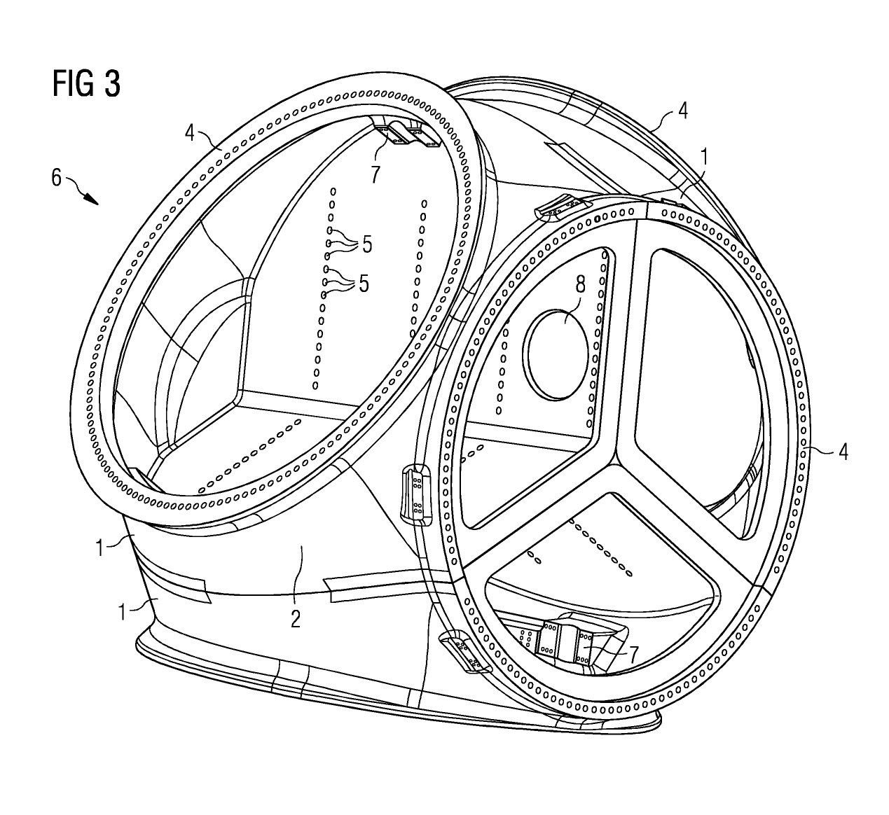

FIG. 3 shows an embodiment of a wind turbine hub.

### DETAILED DESCRIPTION

FIG. 1 shows a wind turbine hub segment 1. The wind turbine hub segment 1 comprises a part of the outer surface 2 of a hub 6. The outer surface 2 of a hub 6 is a surface that is visible from the outside of the hub when the segments are connected to form a hub 6 of wind turbine.

The wind turbine hub segment 1 comprises an area to connect a segment to another segment of a wind turbine hub. This area comprises a mainly closed surface 3. The wind turbine hub segment 1 is hollow and the mainly closed surface 3 is the surface of a wall of the wind turbine hub segment 1.

Holes 5 are arranged in the wall of the wind turbine hub segment 1 to be used with connection means like bolts or rivets. In addition, an opening 8 is arranged in the wall of the wind turbine hub segment 1. The opening 8 provides a through going connection from one wind turbine hub segment 1 to a neighboring wind turbine hub segment 1 that can be used for electrical cables or hydraulic connections.

The segment 1 shows an area 4 to connect a rotor blade to the segment. The area 4 to connect a rotor blade is a part of the outer surface 2 of the wind turbine hub segment 1.

In addition, the wind turbine hub segment 1 comprises an area 7 to mount a component in the hub segment 1. A component to mount at the area 7 can be for example a part of a pitch system of the wind turbine. A pitch system of a wind turbine is used to rotate the rotor blade in respect to the hub of the turbine.

The wind turbine hub segment 1 in FIG. 1 shows two surfaces 3, thus two walls 3, that closes the wind turbine hub segment 1 so that the segment forms a hollow body. Due to the walls that close the wind turbine hub segment 1, the segment 1 shows a higher stability and a higher stiffness.

FIG. 2 shows a plurality of wind turbine hub segments 1 that are arranged to be connected to form a hub of a wind turbine. In the exemplary embodiment shown in FIG. 3, three wind turbine hub segments are shown. Each of the segments 1 comprises a part of the outer surface 2 of the hub.

The segments show a mainly closed surface 3 to connect the wind turbine hub segments 1 together. Holes 5 are arranged in a mainly closed surface 3. The wind turbine hub segments 1 can be connected by connection means through the holes 5 that are distributed over the surface 3.

Each of the wind turbine hub segments 1 comprises an area 4 to connect a rotor blade to the wind turbine hub segment 1. An electrical or hydraulically component like a pitch system can be connected to the wind turbine hub segment 1 at the area 7.

FIG. 3 shows a wind turbine hub 6 that comprises a plurality of, such as three, wind turbine hub segments 1. Each of the wind turbine hub segments 1 shows an area 4 to connect a rotor blade to the wind turbine hub.

Electrical or hydraulically components can be mounted to the area 7 in the wind turbine hub segments 1. Holes 5 are arranged in the walls of the wind turbine hub segments to be used by bolts or rivets to connect wind turbine hub segments 1 together.

The walls of the wind turbine hub segments 1 abut on each other along the surface 3 to form inner walls in the hollow body of the wind turbine hub 6. Each of the wind turbine hub segments 1 comprises a part of the outer surface 2 of the wind turbine hub 6.

An opening 8 is provided in the walls of the wind turbine hub segments 1 to provide a through going opening to be used by electric connections of hydraulic connections, for example, for the pitch system.

Although the present invention has been described in detail with reference to the preferred embodiment, it is to be understood that the present invention is not limited by the disclosed examples, and that numerous additional modifications and variations could be made thereto by a person skilled in the art without departing from the scope of the invention.

It should be noted that the use of “a” or “an” throughout this application does not exclude a plurality, and “comprising” does not exclude other steps or elements. Also elements described in association with different embodiments may be combined. It should also be noted that reference signs in the claims should not be construed as limiting the scope of the claims.

1. A wind turbine hub segment, the wind turbine hub segment comprising a part of an outer surface of a hub, and at least one area to connect the wind turbine hub segment to at least one other wind turbine hub segment, wherein the at least one area to connect the wind turbine hub segment comprises a mainly closed surface.

2. The wind turbine hub segment according to claim 1, wherein the wind turbine hub segment is hollow and the mainly closed surface is a wall of the wind turbine hub segment.

3. The wind turbine hub segment according to claim 2, wherein the wall comprises a plurality of holes to be used by a connection means when the wind turbine hub segment is connected to the at least one other wind turbine hub segment.

4. The wind turbine hub segment according to claim 3, wherein the connection means are at least one of a plurality of bolts and a plurality of rivets.

5. The wind turbine hub segment according to claim 2, wherein the wall is prepared and arranged in a way that the connection to the at least one other wind turbine hub segment is established by welding.

6. The wind turbine hub segment according to claim 2, wherein the wall comprises an opening to be used by an electric or hydraulic connection to connect an electric system or a hydraulic system that is used in the hub of a wind turbine.

7. The wind turbine hub segment according to claim 1, further comprising a second connection area to connect a rotor blade to the wind turbine hub segment.

8. The wind turbine hub segment according to claim 1, wherein a hollow inner space of the wind turbine hub segment comprises at least a part of a pitch system and/or a control system and/or a pitch locking system.

9. A wind turbine hub comprising:
at least one wind turbine hub segment according to claim 1.

10. The wind turbine hub according to claim 9, further comprising a plurality of segments.

11. The wind turbine hub according to claim 10, further comprising a plurality of identical segments to form a hollow structure of the hub.

12. The wind turbine hub according to claim 9, further comprising a plurality of connection areas to connect a rotor blade.

13. The wind turbine hub according to claim 9, further comprising three segments.

14. The wind turbine hub according to claim 13, further comprising three identical segments to form a hollow structure of the hub.

15. The wind turbine hub according to claim 13, further comprising three connection areas to connect a rotor blade.
